(19) United States
(12) Patent Application Publication
(10) Pub. No.: US 2026/0097616 A1
(43) Pub. Date: Apr. 9, 2026

(54) TRAILER TOW CONNECTOR

(71) Applicant: STONERIDGE CONTROL DEVICES, INC., NOVI, MI (US)

(72) Inventors: Cesar Gerardo Ramos Martinez, Juarez (MX); Andres Julian Flores Ceja, Juarez (MX)

(21) Appl. No.: 19/352,629

(22) Filed: Oct. 8, 2025

Related U.S. Application Data
(60) Provisional application No. 63/704,831, filed on Oct. 8, 2024.

(51) Int. Cl. B60D 1/64; H01R 13/447

(52) U.S. Cl. CPC B60D 1/64; H01R 13/447; H01R 2201/26

(57) ABSTRACT

A trailer tow connector (TTC) for a vehicle includes a housing having first and second bodies providing first and second electrical connections. The housing has a first hinge post integrally formed therewith, a first cover with a central hinge portion, and a second cover with first and second lateral hinge portions. The covers are arranged over the first and second bodies in closed positions. The first lateral hinge portion is between the first hinge post and the central portion, and the second lateral hinge portion is outside the central hinge portion opposite the first. A second hinge post is mounted to the housing from an unassembled to an assembled position and supports a pin extending through the hinge portions into the first hinge post, with the second lateral hinge portion captured between the central hinge portion and the second hinge post.

### CROSS-REFERENCE TO RELATED APPLICATION

This application claims priority to U.S. Provisional Application No. 63/704,831 filed Oct. 8, 2024.

### TECHNICAL FIELD

This disclosure relates to a trailer tow connector for a tow vehicle.

### BACKGROUND

Various systems from a trailer must be connected to a tow vehicle, such as a passenger truck. Conventionally either one of a combination 4-way and 7-way trailer tow connector is removably connected to a corresponding trailer connector. This enables the trailer's parking brake lights, turn signals, and brake lights to be operated in unison with the vehicle's lights. In the case of a 7-way connector, the vehicle may also operate electric trailer brakes through the trailer tow connector and trailer connect junction. There are also trailer tow connectors with other types of electrical connectors.

It is desirable to keep the trailer tow connector's electrical connections free from water, salt, dirt and other debris when not in use to prevent corrosion. To this end, a spring-biased hinged cover is provided over each electrical connection to cover the electrical connector. Despite this approach, water and debris may still reach the electrical connections. It is also desirable to provide a trailer tow connector that is easy to assembly and visually appealing.

### SUMMARY

In one exemplary embodiment, a trailer tow connector (TTC) for a vehicle used in towing a trailer includes a housing that has first and second bodies that respectively provide first and second electrical connections, the housing has a first hinge post that is integrally formed therewith, a first cover with a central hinge portion, and a second cover that has first and second lateral hinge portions, the first and second covers are respectively arranged over the first and second bodies in closed positions, the first lateral hinge portion is arranged laterally between the first hinge post and the central portion, and the second lateral hinge portion is arranged outside the central hinge portion opposite the first lateral hinge portion, and a second hinge post that is mounted to the housing from an unassembled position to an assembled position, the second hinge post supports a pin in the assembled position that extends through the first and second lateral hinge portions, the central hinge portion and into the first hinge post, and the second lateral hinge portion is captured between the central hinge portion and the second hinge post in the assembled position.

In a further embodiment of any of the above, the second hinge post has a base, and one of the housing and the base includes spaced apart channels, and the other of the housing and the base includes spaced apart legs that are received in the channels in the assembled position.

In a further embodiment of any of the above, one of the housing and the base includes a latch, and the other of the housing and the base includes a protrusion that cooperates with the latch to retain the second hinge post in the assembled position.

In a further embodiment of any of the above, the pin includes opposing ends that are arranged inboard of an aesthetic exterior of the TCC such that the ends are not visible.

In a further embodiment of any of the above, the pin is a discrete structure from the second hinge post. The pin is of a first material and the second hinge post is of a second material different than the first material.

In a further embodiment of any of the above, the central portion includes first and second lateral walls that are spaced apart from one another, and the pin, in the assembled position, is received in a bore in the first hinge post, in a first hole in the first lateral hinge portion, in first and second openings respectively in the first and second lateral walls, and in a second hole in the second lateral hinge portion.

In a further embodiment of any of the above, the TTC includes a spring that is arranged relative to the first and second covers to bias the first and second covers to the closed positions relative to the housing. The pin extends through the spring that is arranged between the first and second lateral walls.

In a further embodiment of any of the above, the spring includes spaced apart coils. A terminal end extends from each coil in a first direction and is received in a first pocket in the first cover, and a closed portion joins the coils and extends in a second direction different than the first direction. The closed portion has a closed end that is received in a second pocket in the second cover. The pin extends through the coils.

In a further embodiment of any of the above, the housing provides an outer perimeter wall that is configured to abut a structure with the trailer tow connector in an installed position. An aesthetic perimeter is provided by the first and second covers. The aesthetic perimeter substantially conceals the outer perimeter wall with the first and second covers in the closed position.

In a further embodiment of any of the above, the second hinge post includes a base, and the base overlaps a portion of the outer perimeter wall to substantially conceal the portion.

In a further embodiment of any of the above, the first and second covers provide an exterior aesthetic face that substantially covers the spring. The aesthetic perimeter is provided by the first and second covers and circumscribes the exterior aesthetic face.

In a further embodiment of any of the above, a vehicle that includes the trailer tow connector includes a structure having an aperture that receives the housing. The housing has a first end on a first side of the structure and includes the first and second bodies. The aesthetic perimeter provides an outermost perimeter of the TCC substantially around the outer perimeter wall of the TCC on the first side.

In a further embodiment of any of the above, the housing has a second end opposite the first end and is arranged on a second side of the structure opposite the first side. The second end provides an electrical connector that is connected to a wiring harness of the vehicle.

In another exemplary embodiment, a method of assembling a trailer tow connector (TCC) includes securing a second hinge post to a housing that has first and second electrical connections in order to retain first and second covers that are respectively arranged over the first and second electrical connections, and upon performing the securing step, a pin is retained by the second hinge post and a first hinge post that is integrally formed with the housing, and the first and second covers are pivotable about the pin.

In a further embodiment of any of the above, the securing step includes providing the housing with first and second bodies that respectively provide the first and second electrical connections, arranging a spring relative to first and second covers, the first cover has a central hinge portion, and the second cover has spaced apart first and second lateral hinge portions, positioning the first and second covers respectively over the first and second bodies, the first lateral hinge portion is arranged laterally between the first hinge post and the central portion, and the second lateral hinge portion is arranged outside the central hinge portion opposite the first lateral hinge portion, and inserting the pin through holes in the first and second lateral hinge portions, the central hinge portion and the first hinge post, and the second lateral hinge portion is captured between the central hinge portion and the second hinge post.

In a further embodiment of any of the above, the pin is supported by the second hinge post prior to the inserting step.

In a further embodiment of any of the above, the securing step includes retaining the second hinge post to the housing with a latch.

### BRIEF DESCRIPTION OF THE DRAWINGS

The disclosure can be further understood by reference to the following detailed description when considered in connection with the accompanying drawings wherein:

FIG. 1 is a schematic view of a tow vehicle and a trailer with connectors that cooperate with one another to provide an electrical connection between the vehicle and trailer.

FIG. 2 illustrates a top perspective view of a combination trailer tow connector (TTC) with first and second covers in a closed position.

FIG. 3 depicts a perspective view of a housing of the TTC.

FIG. 4 is an enlarged view of a latch on the housing used to retain a mountable hinge post.

FIG. 5 is a cross-sectional perspective view of the TCC through a first hinge post and illustrating a second hinge post about to be inserted into the housing.

FIG. 6 is a perspective view of the second hinge post and its pin.

FIG. 7 is perspective view illustrating the second hinge post about to be inserted into the housing.

FIG. 8 is a cross-sectional perspective view of the second hinge post mounted to the housing with the pin fully inserted.

FIG. 9 is an enlarged view of the latch securing the second hinge post to the housing.

The embodiments, examples and alternatives of the preceding paragraphs, the claims, or the following description and drawings, including any of their various aspects or respective individual features, may be taken independently or in any combination. Features described in connection with one embodiment are applicable to all embodiments unless such features are incompatible.

### DETAILED DESCRIPTION

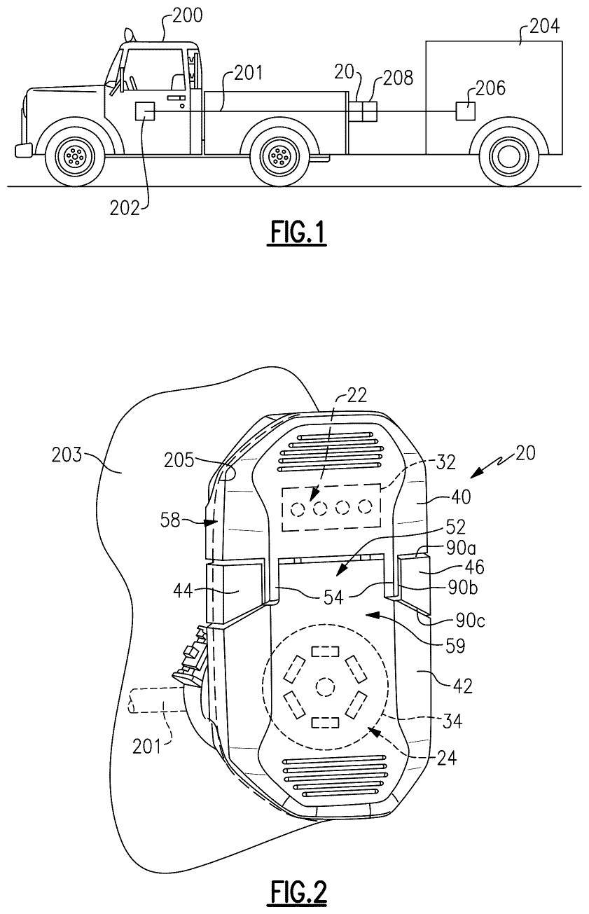

A tow vehicle 200 towing a trailer 204 is illustrated in FIG. 1. The vehicle 200 includes a power source 202 that supplies electrical power to a vehicle electrical system, which includes, for example, parking lights, brake lights, turn signals, and backup lights. The tow vehicle 200 includes a trailer tow connector (TTC) 20 connected to the vehicle electrical system via a wiring harness 201.

The trailer 204 includes a trailer electrical system that includes, for example, parking lights, brake lights, turn signals, backup lights, and an electric brake system. The vehicle and the trailer electrical systems are electrically connected to one another by the TTC 20 on the tow vehicle 200 that interconnects to a trailer connector 208 on a wiring harness or pigtail that is electrically connected to the trailer electrical system.

The electrical connection between the TTC 20 and the trailer connector 208 must be robust and reliable to ensure power to the trailer electrical system 18 during operation. This may become difficult due to corrosion in the connector's terminals. To this end, the disclosed trailer TTC 20 provides an improved weather-tight arrangement while also being easy to assembly and aesthetically pleasing, which are difficult objectives to achieve together.

An example standard TTC 20 is shown in FIG. 2 and provides a combination 4-“way”/7-“way” (or “pole” or “terminal”) connector, for example, which is shown in phantom. It should be understood that this disclosure encompasses other types or configurations of trailer tow connectors than those described herein. That is, the first and second cover 40, 42 may be arranged over other types of electrical connectors. The housing 26 includes first and second bodies 32, 34 at the first end 28, which respectively provide the 4-way connector and the 7-way connector. First and second covers 40, 42 are respectively arranged over the first and second bodies 32, 34 and are pivotal about a hinge 36 having a common pin 38 (FIG. 8) in the example.

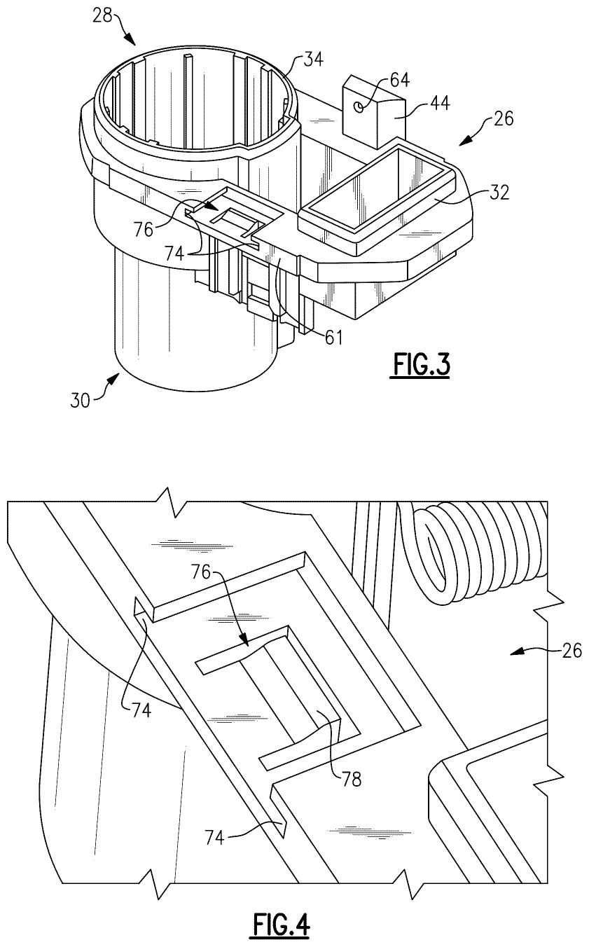

The example TTC 20 includes a plastic housing 26 providing first and second ends 28, 30 opposing one another. The first end 28 is arranged facing the exterior of the tow vehicle 200, typically near and outwardly accessible relative to the vehicle's rear bumper. More specifically, a structure 203, such as the vehicle's 200 bumper, has an aperture 205 receiving the housing 26. Referring to FIGS. 2 and 3, the first end 28 is arranged on a first (outer) side of the bumper. The second end 30 is arranged on a second (inner) side of the bumper and is connected to the wiring harness 201 of the vehicle 200.

Referring to FIG. 3, the housing 26 is illustrated as a modular design in which different electrical connectors having different configurations may be inserted into the housing 26 to provide versatility in manufacturing different TCC's based upon customer requirements without having to re-tool for the particular TCC. For example, the electrical connectors that a manufacturer may typically choose from include a 7-way connector, a 4-way connector, a 12-way connector, a data connector (e.g., coaxial, USB, etc.), and an electrical outlet (e.g., 12 volt, 110 volt AC, etc). Of course, other electrical connectors may also be used. This type of TCC modular design is disclosed in U.S. Ser. No. 18/745,202, entitled “MODULAR TRAILER TOW CONNECTOR”, filed on Jun. 17, 2024, which is incorporated herein by reference in its entirety.

One or more springs 70 bias the first and second covers 40, 42 to a closed position over the terminals 46 to provide a weather-tight seal, as shown in FIGS. 5 and 8. FIG. 2 depicts both covers in a closed position. An improved weather-tight cover arrangement is disclosed in U.S. Ser. No. 18/525,340, entitled “TRAILER TOW CONNECTOR”, filed on Nov. 30, 2023, which is incorporated herein by reference in its entirety. The covers are designed to have an aesthetic appearance as well as enclose a perimeter of the housing 26 more effectively.

One of the desired features of an aesthetic appearance for a TCC is that the pin 38 for the hinge 36 not be visible from the TCC's exterior. This makes design and assembly of an aesthetically pleasing TCC difficult. The disclosed TCC 20 addresses these challenges.

The housing 26 has a first hinge post 44 integrally formed therewith. In one example, the first hinge post 44 is formed during the injection mold process that produces the housing, i.e., in the same injection mold at the same time from the same material. Generally, the first and second covers 40, 42 are supported by the pin 70, which is in turn supported by the first hinge post 44 and a discrete, second hinge post 46 that is mounted and secured to the housing 26 during the assembly process.

More specifically, as shown in FIGS. 2, 5 and 8, the first cover 40 has a central hinge portion 52 with lateral walls 55, and the second cover 42 has first and second lateral hinge portions 54. The first and second covers 40, 42 are respectively arranged over the first and second bodies 32, 34 in closed positions. One of the lateral hinge portions 54 is arranged laterally between the first hinge post 44 and the central portion 52, and the other lateral hinge portion 54 is arranged outside the central hinge portion 52 opposite the one lateral hinge portion 54 The second hinge post 46 is mounted to the housing 36 from an unassembled position (FIG. 5) to an assembled position (FIG. 8). The second hinge post 46 supports the pin 38 in the assembled position such that the pin 38 extends through the lateral hinge portions 54, the central hinge portion 52 and its spaced apart lateral walls 55 and into the first hinge post 44. The lateral hinge portion 54 farthest from the first hinge post 44 is captured between the central hinge portion 52 and the second hinge post 56 in the assembled position (FIG. 8).

When assembled, a first end 38a of the pin 38 is received in a bore 64 in the first hinge post 44. The pin 38 arranged in a hole 62 in each of the lateral hinge portions 54, and in openings in the lateral walls 55 in the central hinge portion 52. In the example, the pin 38 is a discrete structure from the second hinge post 46, and the pin 38 is made of a first material (e.g., metal) and the second hinge post is of a second material (e.g., plastic) that is different than the first material. The pin 38 includes a second end 38b that mounted in the second hinge post 46. Both ends 38a, 38b are arranged inboard of an aesthetic exterior of the TCC 20 such that the ends are not visible. The pin 38 could be constructed integrally with the second hinge post 38 and of the same material (i.e., a single molded unitary plastic piece).

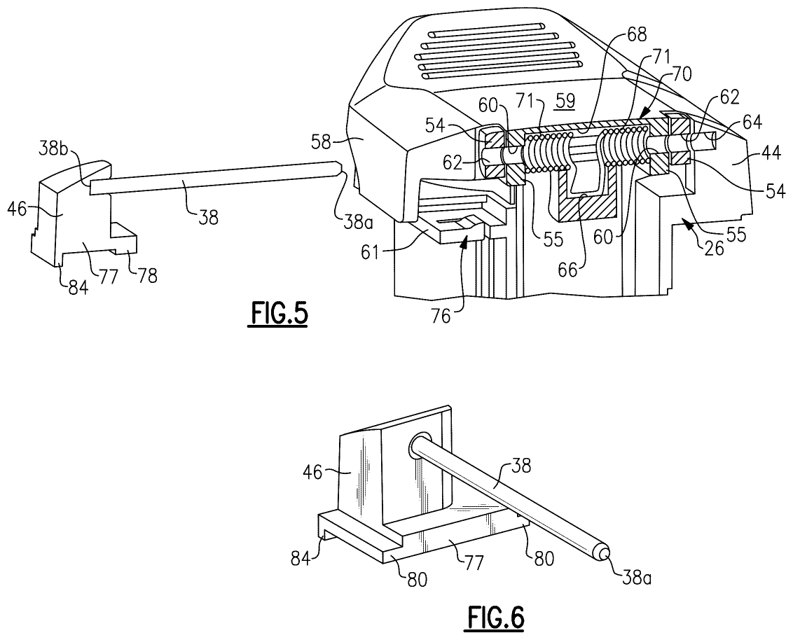

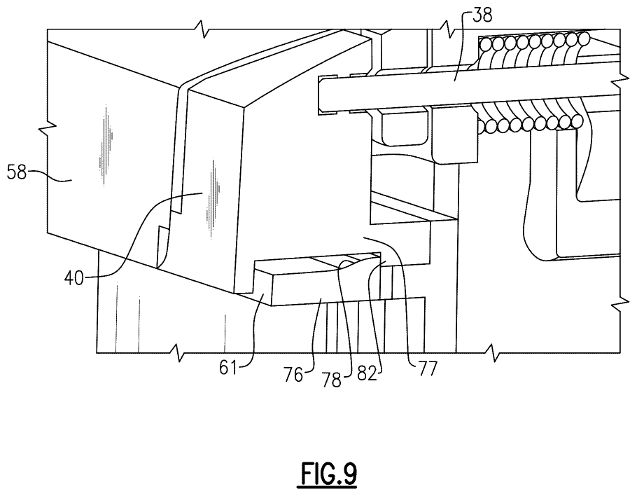

Referring to FIGS. 5-9, the second hinge post 46 has a base 77. One of the housing 26 and the base 77 includes spaced apart channels 74, and the other of the housing 26 and the base 77 includes spaced apart legs 80 received in the channels 74 in the assembled position. One of the housing 26 and the base 77 includes a latch 76. The other of the housing 26 and the base 77 includes a protrusion 82 that cooperates with a lip 78 on the latch 76 to retain the second hinge post 46 in the assembled position (FIGS. 8-9).

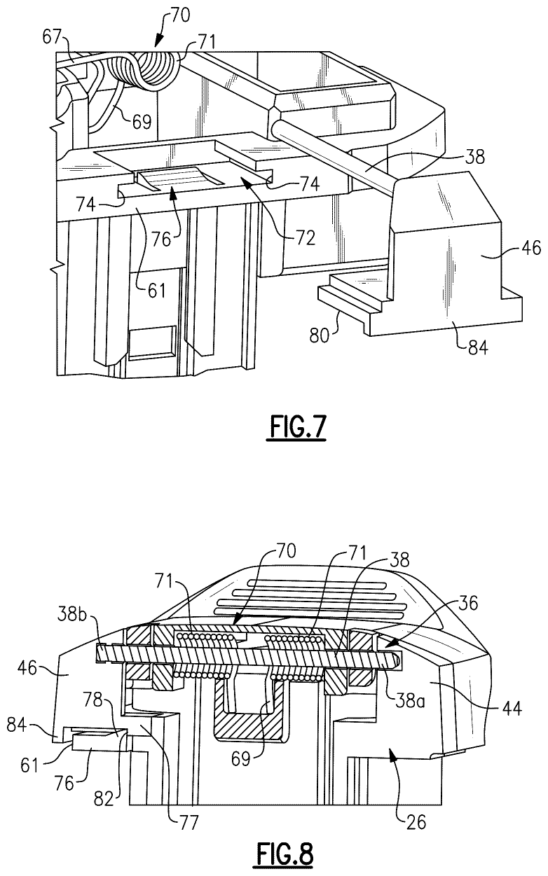

The spring 70 is arranged substantially beneath the first and second covers 40, 42 so it is generally not readily visible (see, FIG. 2). In the example, the spring 70 is provided by spaced apart coils 74 through which the pin 38 extends (FIG. 8). A terminal end 67 (FIG. 7) extends from each coil 74 is received in a first pocket 71 in one of the first and second covers 40, 42. A closed portion 69 joins the coils 74 and extends in another direction than the terminal ends 69. The closed portion 78, which is U-shaped, has a closed end received in a second pocket 66 (FIG. 5) in the other of the first and second covers 40, 42.

The first and second covers 40, 42 provide an exterior aesthetic face 59 substantially covering the spring 70. An aesthetic perimeter 58 provided by the first and second covers 40, 42 circumscribes the exterior aesthetic face 59. The base 77 includes a ledge 84 that substantially covers a nearby portion of the outer perimeter wall 61 of the housing 26. The aesthetic perimeter 58 of the covers substantially cover the remaining the outer perimeter wall 61 to reduce water and debris intrusion. Decorative grooves 90a-90c are provided about each of the first and second hinge posts 44, 46.

The trailer tow connector 20 is assembled by arranging the spring 70 relative to first and second covers 40, 42. The second hinge post 46 is secured to the housing 26 in order to retain first and second covers 40, 42 respectively arranged over the first and second electrical connections 22, 24. When securing the second hinge post 46 to the housing 26, a pin 38 is retained by the first and second hinge post 44, 46 such that the first and second covers 40, 42 are pivotable about the pin 38. The second hinge post 46 is retained to the housing 26 with a latch 76.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

1. A trailer tow connector (TTC) for a vehicle used in towing a trailer, comprising:
a housing having first and second bodies respectively providing first and second electrical connections, wherein the housing has a first hinge post integrally formed therewith;
a first cover with a central hinge portion, and a second cover has first and second lateral hinge portions, the first and second covers respectively arranged over the first and second bodies in closed positions, wherein the first lateral hinge portion is arranged laterally between the first hinge post and the central portion, and the second lateral hinge portion is arranged outside the central hinge portion opposite the first lateral hinge portion; and
a second hinge post mounted to the housing from an unassembled position to an assembled position, the second hinge post supports a pin in the assembled position that extends through the first and second lateral hinge portions, the central hinge portion and into the first hinge post, and wherein the second lateral hinge portion is captured between the central hinge portion and the second hinge post in the assembled position.

2. The TTC of claim 1, wherein second hinge post has a base, and one of the housing and the base includes spaced apart channels, and the other of the housing and the base includes spaced apart legs received in the channels in the assembled position.

3. The TTC of claim 2, wherein one of the housing and the base includes a latch, and the other of the housing and the base includes a protrusion that cooperates with the latch to retain the second hinge post in the assembled position.

4. The TTC of claim 1, wherein the pin includes opposing ends that are arranged inboard of an aesthetic exterior of the TCC such that the ends are not visible.

5. The TTC of claim 4, wherein the pin is a discrete structure from the second hinge post, wherein the pin is of a first material and the second hinge post is of a second material different than the first material.

6. The TTC of claim 1, wherein the central portion includes first and second lateral walls spaced apart from one another, and wherein the pin, in the assembled position, is received in a bore in the first hinge post, in a first hole in the first lateral hinge portion, in first and second openings respectively in the first and second lateral walls, and in a second hole in the second lateral hinge portion.

7. The TTC of claim 6, comprising a spring arranged relative to the first and second covers to bias the first and second covers to the closed positions relative to the housing, wherein the pin extends through the spring arranged between the first and second lateral walls.

8. The TTC of claim 7, wherein the spring includes spaced apart coils, a terminal end extending from each coil in a first direction and received in a first pocket in the first cover, and a closed portion joining the coils and extending in a second direction different than the first direction, the closed portion having a closed end received in a second pocket in the second cover, the pin extending through the coils.

9. The TTC of claim 7, wherein the housing provides an outer perimeter wall configured to abut a structure with the trailer tow connector in an installed position, an aesthetic perimeter is provided by the first and second covers, the aesthetic perimeter substantially concealing the outer perimeter wall with the first and second covers in the closed position.

10. The TTC of claim 9, wherein the second hinge post includes a base, and the base overlaps a portion of the outer perimeter wall to substantially conceal the portion.

11. The TTC of claim 9, wherein the first and second covers provide an exterior aesthetic face substantially covering the spring, the aesthetic perimeter provided by the first and second covers and circumscribing the exterior aesthetic face.

12. A vehicle including the trailer tow connector of claim 9, comprising a structure having an aperture receiving the housing, the housing having a first end on a first side of the structure and including the first and second bodies, the aesthetic perimeter providing an outermost perimeter of the TTC substantially around the outer perimeter wall of the TTC on the first side.

13. The vehicle of claim 12, wherein the housing has a second end opposite the first end and arranged on a second side of the structure opposite the first side, the second end providing an electrical connector connected to a wiring harness of the vehicle.

14. A method of assembling a trailer tow connector (TTC), comprising:
securing a second hinge post to a housing having first and second electrical connections in order to retain first and second covers respectively arranged over the first and second electrical connections; and
wherein upon performing the securing step, a pin is retained by the second hinge post and a first hinge post that is integrally formed with the housing, and wherein the first and second covers are pivotable about the pin.

15. The method of claim 14, wherein the securing step includes:
providing the housing with first and second bodies respectively providing the first and second electrical connections;
arranging a spring relative to first and second covers, wherein the first cover has a central hinge portion, and the second cover has spaced apart first and second lateral hinge portions;
positioning the first and second covers respectively over the first and second bodies, wherein the first lateral hinge portion is arranged laterally between the first hinge post and the central portion, and the second lateral hinge portion is arranged outside the central hinge portion opposite the first lateral hinge portion; and
inserting the pin through holes in the first and second lateral hinge portions, the central hinge portion and the first hinge post, and wherein the second lateral hinge portion is captured between the central hinge portion and the second hinge post.

16. The method of claim 15, wherein the pin is supported by the second hinge post prior to the inserting step.

17. The method of claim 14, wherein the securing step includes retaining the second hinge post to the housing with a latch.
